(19) United States
(12) Patent Application Publication
(10) Pub. No.: US 2017/0257689 A1
(43) Pub. Date: Sep. 7, 2017

(54) BRACKET SYSTEM TO HEIGHT-ALIGN PERIMETER AND AERIAL SPEAKERS FOR AN ENHANCED SOUND SYSTEM

(71) Applicant: SONY CORPORATION, TOKYO (JP)

(72) Inventors: JAMES MILNE, San Diego, CA (US); GREGORY CARLSSON, San Diego, CA (US)

(21) Appl. No.: 15/063,168

(22) Filed: Mar. 7, 2016

(51) Int. Cl. H04R 1/02; F16M 11/18; F16M 11/06; H04S 7/00; F16M 13/02

(52) U.S. Cl. CPC H04R 1/026; H04S 7/302; F16M 13/02; F16M 11/06; F16M 11/18; H04R 2201/025

(57) ABSTRACT

Various aspects of a bracket system for speakers for a surround sound effect are disclosed herein. In accordance with an embodiment, the bracket system includes a first bracket assembly and a second bracket assembly. The first bracket assembly is adapted to hold a first speaker. The second bracket assembly is adapted to hold a second speaker. The second bracket assembly is mounted on the first bracket assembly. An angle between the second bracket assembly and the first bracket assembly is adjustable for an alignment of sound output from the first speaker within the first bracket assembly and the second speaker within the second bracket assembly.

### CROSS-REFERENCE TO RELATED APPLICATIONS/INCORPORATION BY REFERENCE

None

### FIELD

Various embodiments of the disclosure relate to a bracket system. More specifically, various embodiments of the disclosure relate to a bracket system to height-align speakers for an enhanced sound system.

### BACKGROUND

With advancements in the field of audio technologies, various types of multi-channel speaker systems have become increasingly popular. In certain scenarios, a user has to manually perform configuration and set-up the multi-channel speaker systems to direct sound output from the speakers towards a listening sweet-spot. For instance, a customer may need to buy a ceiling mount speaker, such as an in-ceiling speaker, to create a surround sound system with height capability. Currently, it may be difficult to mount or set-up such ceiling mount speakers such that all the speakers in the ceiling and on the floor are time-aligned to a central location. Further, the set-up may become a time-consuming and tedious task for most users. Hence, an advanced system may be required that assists users to mount various speakers in simplified manner to effectively create an enhanced sound system.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A bracket system for speakers to enhance a sound system substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 illustrates a front view and a side view or an exemplary bracket system for speakers, in accordance with an embodiment of the disclosure.

FIG. 2A illustrates a detailed front view of an exemplary bracket system for speakers, in accordance with an embodiment of the disclosure.

FIG. 2B illustrates a side view of an exemplary bracket assembly of a bracket system, in accordance with an embodiment of the disclosure.

FIG. 3 illustrates an exemplary scenario to depict adjustment of bracket assemblies of a bracket system to align sound output from speakers encased in the bracket system, in accordance with an embodiment of the disclosure.

FIGS. 4A and 4B illustrate exemplary radial patterns of pivotal connectors of a bracket system, in accordance with an embodiment of the disclosure.

FIG. 5 is a block diagram that illustrates an exemplary device for electrical adjustment of a bracket system for speakers to enhance a sound system, in accordance with an embodiment of the disclosure.

FIG. 6 is a flow chart that illustrates a method to control adjustment of a bracket system for speakers to enhance a sound system, in accordance with an embodiment of the disclosure.

### DETAILED DESCRIPTION

The following described implementations may be found in the disclosed bracket system. Exemplary aspects of the disclosure may include a bracket system for speakers. The bracket system may include a first bracket assembly and a second bracket assembly. The second bracket assembly may be mounted on the first bracket assembly, by use of one or more pivotal connectors. The first bracket assembly may be adapted to hold a first speaker. The second bracket assembly may be adapted to hold a second speaker. An angle between the second bracket assembly and the first bracket assembly may be adjustable for an alignment of sound output from the first speaker within the first bracket assembly and the second speaker within the second bracket assembly.

In accordance with an embodiment, at least one of the first bracket assembly or the second bracket assembly may include a power strip to supply electric power to the first speaker and/or the second speaker. Further, at least one of the first bracket assembly or the second bracket assembly may comprise a common network module for the first speaker and the second speaker. In accordance with an embodiment, the first speaker may correspond to a base speaker or a floor standing speaker. The second speaker may correspond to an aerial speaker. In accordance with an embodiment, the first speaker may correspond to a perimeter speaker of a surround sound system. The second speaker may correspond to an aerial speaker of the surround sound system.

In accordance with an embodiment, the alignment of the sound output from the first speaker within the first bracket assembly and the second speaker within the second bracket assembly may correspond to a time-alignment, a phase-alignment, and/or height-time alignment. In accordance with an embodiment, a first sound output from the first speaker may be time-aligned with respect to a second sound output from the second speaker, based on the adjustment of the angle. Further, the first sound output and the second sound output may be phase-aligned, based on the adjustment of the angle.

In accordance with an embodiment, the first speaker may be aligned with respect to the second speaker such that the first speaker and the second speaker may be equidistant from a target listening position, based on the adjustment of the angle. In accordance with an embodiment, a sound emitting side of each of the first speaker and the second speaker may be directed to face towards the target listening position for the alignment of the sound output.

In accordance with an embodiment, the first bracket assembly and/or the second bracket assembly may comprise a clamp, a padded plate, a bracket member, and/or a grid rail, which may be adapted to hold the first speaker within the first bracket assembly and/or the second speaker within the second bracket assembly. One end of the first bracket assembly may be attached on a mount by use of one or more fasteners.

In accordance with an embodiment, the angle between the first bracket assembly and the second bracket assembly may be adjustable through a mechanical adjustment unit by use of the one or more pivotal connectors. The one or more pivotal connectors may adjustably connect the second bracket assembly and the first bracket assembly. In accordance with an embodiment, the angle between the first bracket assembly and the second bracket assembly may be adjustable through an electrical adjustment unit associated with the one or more pivotal connectors. The electrical adjustment unit may include a motor and one or more circuits. The one or more circuits may be configured to control the motor. The motor may be a step motor or a servo motor.

In accordance with an embodiment, the one or more circuits may be configured to receive one or more control commands from an electronic device for the adjustment of the angle between the second bracket assembly and the first bracket assembly. Further, the one or more circuits may be configured to determine a phase difference between the first sound output and the second sound output. In such a scenario, the angle between the second bracket assembly and the first bracket assembly may be automatically adjusted, based on the determined phase difference.

In accordance with an embodiment, the first speaker and/or the second speaker may comprise one or more speaker drivers. The one or more speaker drivers may correspond to height channels that may be aligned by use of the first bracket assembly and the second bracket assembly to produce a surround sound multi-channel audio, based on the adjustment of the angle.

In accordance with an embodiment, the first bracket assembly may be vertically and/or horizontally adjustable, based on the dimensions of the first speaker to accommodate the first speaker. Similarly, the second bracket assembly may be vertically and/or horizontally adjustable, based on the dimensions of the second speaker to accommodate the second speaker.

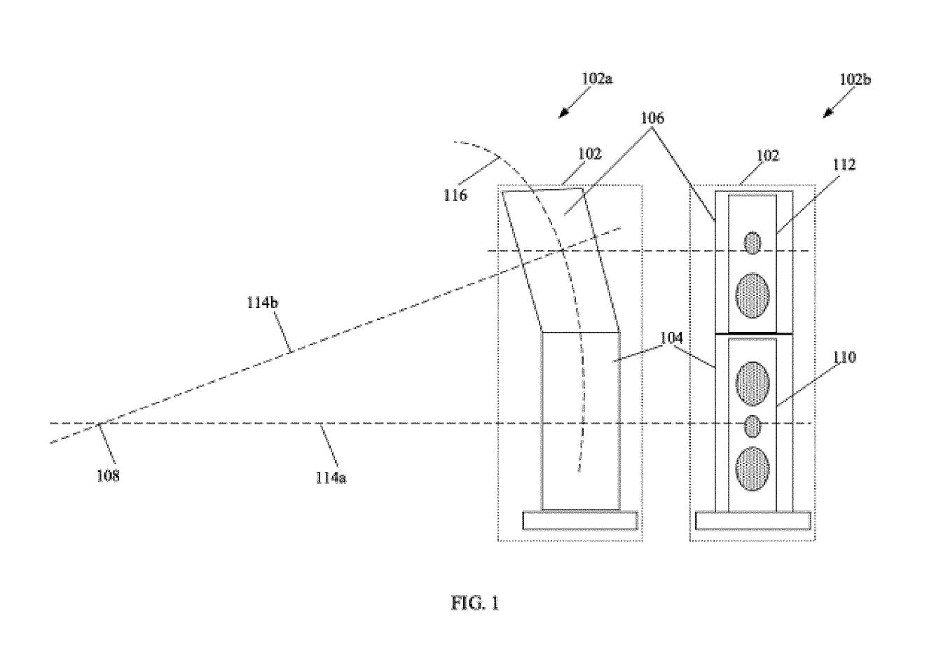

FIG. 1 illustrates a front view and a side view of an exemplary bracket system for speakers, in accordance with an embodiment of the disclosure. With reference to FIG. 1, there is shown a side view 102a and a front view 102b of a bracket system 102. The bracket system 102 may include a first bracket assembly 104 and a second bracket assembly 106. There is further shown a target listening position 108, a first speaker 110, and a second speaker 112. The first bracket assembly 104 may be adapted to hold the first speaker 110. The second bracket assembly 106 may be adapted to hold the second speaker 112. There is further shown a first distance 114a, a second distance 114b, and a hemispherical radius 116.

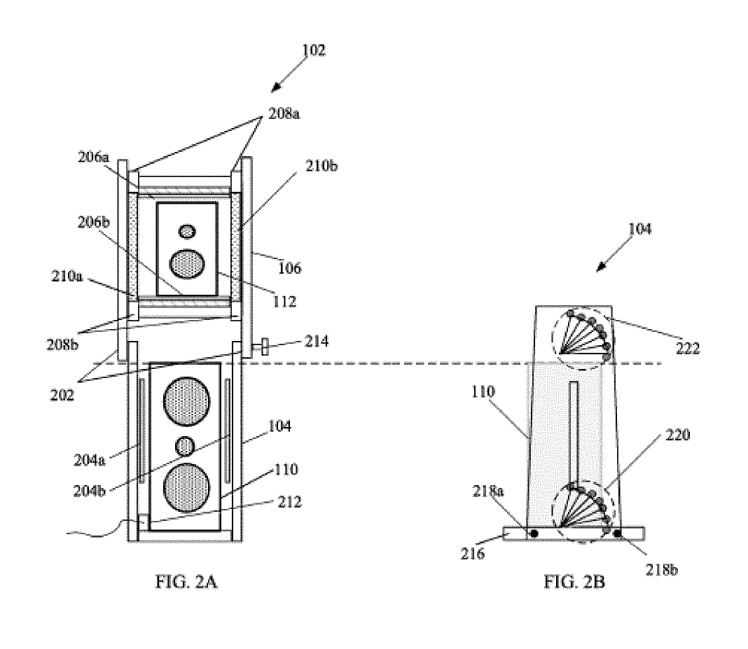

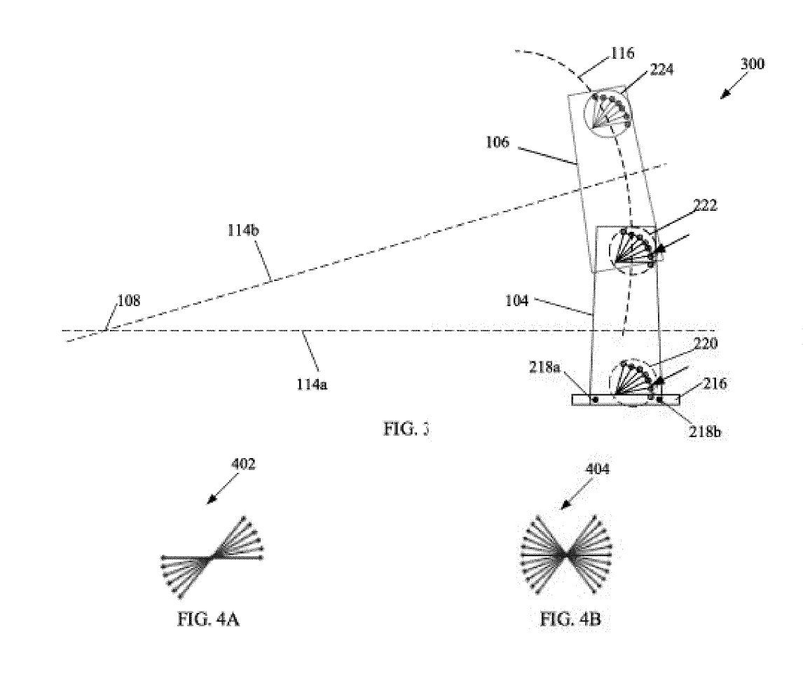

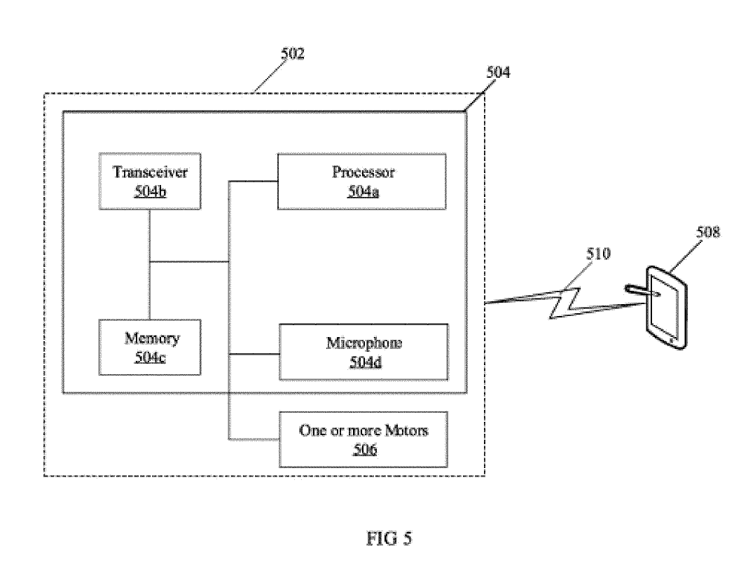

In accordance with an embodiment, the bracket system 102 may be provided with at least two bracket assemblies, such as the first bracket assembly 104 and the second bracket assembly 106. The two bracket assemblies may be stacked within the bracket system 102 and adjustably tilted with respect to one another. For instance, the second bracket assembly 106 may stacked on the first bracket assembly 104. One end of the first bracket assembly 104 may be attached with a platform that may be placed on a floor. Further, the second bracket assembly 106 may be tilted with respect to the first bracket assembly 104, using one or more adjustable mounts. For example, the one or more adjustable mounts may be implemented as one or more pivotal connectors that may connect the first bracket assembly 104 with the second bracket assembly 106. The one or more pivotal connectors may be an angular adjustment arrangement such that an angle between the first bracket assembly 104 and the second bracket assembly 106 may be adjusted by insertion of connectors at an appropriate angular position. The one or more pivotal connectors are further explained in FIG. 2B, FIG. 3, FIG. 4A and FIG. 4B. In accordance with an embodiment, the angle between the first bracket assembly 104 and the second bracket assembly 106 may be adjusted for alignment of sound output from the first speaker 110 and the second speaker 112.

In accordance with an embodiment, each of the first bracket assembly 104 and the second bracket assembly 108 may include one or more assembly elements that may be adapted to hold or encase the first speaker 110 and the second speaker 112, respectively. Examples of the one or more assembly elements may include, but may not be limited to, one or more clamps, one or more horizontal plates held between the one or more clamps, and/or one or more grid rails vertically supporting the one or more clamps between a top end and a bottom end of the first bracket assembly 104, and/or the second bracket assembly 106. The one or more assembly elements are explained further in FIG. 2A and FIG. 2B.

In accordance with an embodiment, each of the first speaker 110 and/or the second speaker 112 may correspond to audio output devices that may be configured to generate sound output. In accordance with an embodiment, a first sound channel associated will the first speaker 110 may be up-mixed with a second sound channel associated with the second speaker 112 to create a surround sound effect. In accordance with an embodiment, a higher frequency sound output may be generated by the first speaker 110 as compared to sound output by the second speaker 112.

In accordance with an embodiment, the first speaker 110 and/or the second speaker 112 may comprise one or more speaker drivers. The one or more speaker drivers may correspond to height channels that may be aligned by use of the first bracket assembly 104 and the second bracket assembly 106 to produce a surround sound multi-channel audio based on the adjustment of the angle. The bracket system 102 may make possible to convert a “n.1”-channel sound system to a “n*2.1” or “n+x.2” channel sound system due to the aerial positing or stacking of the speaker systems to create an enhanced surround sound effect, where “n” and “x” may correspond to a positive integer. For example, a 5.1 or 7.1 channel sound system may be converted to a 10.2 channel sound system by use of height channels positioned by use of the bracket system 102.

In accordance with an embodiment, several speakers in a plurality of bracket systems, such as the bracket system 102, may be networked together to create an added height dimension to existing systems by use of the bracket system 102. In such an embodiment, the sound output and the surround sound effect may be optimized. For example, an existing 2.0, 5.1, or 7.1 speaker configuration may be converted to a 4.0, 10.1, or 14.1 channel sound system based on the added height dimension by use of bracket system 102, as discussed above.

In accordance with an embodiment, the first speaker 110 may be aligned with respect to the second speaker 112 such that the first speaker 110 and the second speaker 112 are equidistant from the target listening position 108, based on the adjustment of the angle. Further, as shown in the side view 102a of the bracket system 102, a sound emitting side of the first speaker 110 and the second speaker 112 may be directed towards the target listening position 108 for the alignment of their sound output.

For example, as shown in the side view 102a of the bracket system 102, the second bracket assembly 106 may be adjustably mounted and tilted over the first bracket assembly 104. The tilt may be adjusted such that the second distance 114b between the second speaker 112 and the target listening position 108 may be equal to the first distance 114a between the first speaker 110 and the target listening position 108. In accordance with an embodiment, the adjustment of the angle between the second bracket assembly 106 and the first bracket assembly 104 may be such that the second bracket assembly 106 may traverse near-hemispherical loci centered at the target listening position 108. The near-hemispherical loci is depicted as the hemispherical radius 116 in the FIG. 1.

A person having ordinary skill in the art may understand that an arrangement for predetermined angular adjustments may be provided by use of one or more pivotal connectors. The one or more pivotal connectors may adjustably connect the second bracket assembly 106 with the first bracket assembly 104. For example, angular increments of 5, 10, 15, 30, 45, and/or 60 degrees, may be possible by use of the one or more pivotal connectors. Examples of the one or more pivotal connectors may include, but may not be limited to, radial pivots, friction mapped plates, hinged plates, or groove-screw mounts.

In accordance with an embodiment, the angle between the first bracket assembly 104 and the second bracket assembly 106 may be adjustable through a mechanical adjustment and/or and electrical adjustment unit. The mechanical adjustment may be performed by use of the one or more pivotal connectors that adjustably connect the first bracket assembly 104 and the second bracket assembly 106. In accordance with an embodiment, the electrical adjustment unit (not shown in FIG. 1) may include a motor and one or more circuits. The one or more circuits may be configured to control the motor for automatic adjustment of the angle between the first bracket assembly 104 and the second bracket assembly 106 to align the sound output of the first speaker 110 and the second speaker 112. Examples of the motor may include, but may not be limited to, a step motor or a servo motor. The motor and the one or more circuits may be associated with the one or more pivotal connectors.

In accordance with an embodiment, the one or more circuits may control the motor for the automatic adjustment, based on one or more commands received from an electronic device. Examples of the electronic device may include, but may not be limited to, a smart-phone, a tablet computer, a smart-watch, a personal computer, one or more sensors (e.g., proximity sensor, light sensor, a presence sensor, and the like), and/or other electronic device.

In accordance with an embodiment, the electrical adjustment unit may include an audio input device, such as a microphone, which may determine a phase different between the first sound output from the first speaker 110 and the second sound output from the second speaker 112. The angle between the second bracket assembly 106 and the first bracket assembly 104 may then be adjusted based on the determined phase difference, such that the phase difference may be reduced to zero or near zero.

In accordance with an embodiment, a first sound output from the first speaker 110 may be time-aligned with respect to a second sound output from the second speaker 112, based on the adjustment of the angle. Further, the first sound output and the second sound output may be phase-aligned, based on the adjustment of the angle. In accordance with an embodiment, the alignment of the sound output from the first speaker 110 within the first bracket assembly 104 and the second speaker 112 within the second bracket assembly 106 may correspond to a time-alignment, a phase-alignment, and/or a height-time alignment.

In accordance with an embodiment, at least one of the first bracket assembly 104 or the second bracket assembly 106 may comprise a power strip (not shown in FIG. 1) to supply electric power to the first speaker 110 and/or the second speaker 112. Further, at least one of the first bracket assembly 104 or the second bracket assembly 106 may comprise a common network module (not shown in FIG. 1) for the first speaker 110 and the second speaker 112. In such a scenario, both the first speaker 110 and the second speaker 112 may be wireless speakers.

In accordance with an embodiment, the first speaker 110 may correspond to a base speaker or a floor standing speaker. The second speaker 112 may be an aerial speaker. In accordance with an embodiment, the first speaker 110 may be a perimeter speaker of a surround sound system, whereas the second speaker 112 may correspond to an aerial speaker or resemble a ceiling speaker of the surround sound system.

FIG. 2A illustrates a detailed front view of an exemplary bracket system for speakers, in accordance with an embodiment of the disclosure. FIG. 2A is explained in conjunction with elements from the FIG. 1. With reference to FIG. 2A, there is shown an exemplary front view of the bracket system 102, the first bracket assembly 104, the second bracket assembly 106, the first speaker 110, and the second speaker 112. There is further shown one or more adjustable mounts 202. The first bracket assembly 104 may include a first vertical padded plate 204a and a second vertical padded plate 204b. The second bracket assembly 106 may include a first horizontal padded plate 206a, a second horizontal padded plate 206b, a first pair of clamps 208a, a second pair of clamps 208b, a first pair of grid rails 210a, and a second pair of grid rails 210b. A power strip 212 and a common network module 214 is also shown in the FIG. 2A.

The first bracket assembly 104 may be adapted to hold or encase the first speaker 110. The second bracket assembly 106 on the other hand, may be adapted to hold the second speaker 112. In accordance with an embodiment, the second bracket assembly 106 may be adjustably mounted on the first bracket assembly 104 by use of the one or more adjustable mounts 202. The first vertical padded plate 204a and the second vertical padded plate 204b may be positioned at vertical inner walls of the first bracket assembly 104, as shown.

The second bracket assembly 106 may include the first horizontal padded plate 206a and the second horizontal padded plate 206b positioned at opposite vertical ends of the second bracket assembly 106, as shown. The first pair of clamps 208a may be adapted to support and/or affix the first horizontal padded plate 206a. The second pair of clamps 208b may be adapted to support and/or affix the second horizontal padded plate 206b between the vertical ends of the second bracket assembly 106, as shown.

The second bracket assembly 106 may include the first pair of grid rails 210a and the second pair of grid rails 210b positioned at opposite vertical inner walls of the second bracket assembly 106. The first pair of grid rails 210a and the second pair of grid rails 210b may be adapted to support the first pair of clamps 208a and the second pair of clamps 208b between the opposite vertical ends of the second bracket assembly 106.

In accordance with an embodiment, the second bracket assembly 106 may be adjustably mounted on the first bracket assembly 104, by use of the one or more adjustable mounts 202. The one or more adjustable mounts 202 may include one or more pivotal connectors that may connect the first bracket assembly 104 and the second bracket assembly 106, to hold the two bracket assemblies 104 and 106 together as a stack. Thus, the second speaker 112, within the second bracket assembly 106, may be stacked over the first speaker 110, within the first bracket assembly 104. The bracket system 102 may encase the first speaker 110 and the second speaker 112, such that the second speaker 112 may be tilted and stacked over the first speaker 110 for a height based alignment.

A person having ordinary skill in the art may understand that though FIG. 2A illustrates that one or more clamps, padded plates, and/or grid rails may be included inside the second bracket assembly 106, the first bracket assembly 104 may also include such components without limiting the scope of the disclosure. In such a scenario, the first bracket assembly 104 may be similar to the second bracket assembly 106. Further, both the first bracket assembly 104 and the second bracket assembly 106, in such a case, may be height and/or width adjustable, to accommodate speakers of various dimensions. In another scenario, the first bracket assembly 104 may include such components, while the second bracket assembly 106 may not. It is to be further understood that the first bracket assembly 104 and the second bracket assembly 106 may be built in various sizes to encase speakers of different dimensions. Further, in certain scenarios, the height of the first bracket assembly 104 or the second bracket assembly 106 may be adjustable to accommodate speakers of various sizes.

In accordance with an embodiment, the bracket system 102 may include the power strip 212 provided in one or both of the first bracket assembly 104 and/or the second bracket assembly 106. The power strip 212 may be configured to supply electric power to a speaker encased within a respective bracket assembly or to supply electric power to multiple speakers. For example, the power strip 212 may be provided at a base of the first bracket assembly 104 to provide electric power to the first speaker 110. Alternatively, the power strip 212 may be provided as a common power supply unit in one of the first bracket assembly 104 or the second bracket assembly 106 to provide electric power to both the first speaker 110 and the second speaker 112. In another scenario, the power strip 212 may be provided along with the one or more adjustable mounts 202 that may be configured to connect the first bracket assembly 104 and the second bracket assembly 106.

In accordance with an embodiment, the common network module 214 may be provided for both the first speaker 110 and the second speaker 112. The common network module 214 may connect the first speaker 110 and/or the second speaker 112 to a communication network (e.g., a Wi-Fi network) that may be used in conjunction with a speaker system to create a surround sound effect.

FIG. 2B illustrates a side view of an exemplary bracket assembly of a bracket system, in accordance with an embodiment of the disclosure. With reference to FIG. 2B, there is shown the first bracket assembly 104. The first bracket assembly 104 is shown to encase the first speaker 110. There is further shown a platform 216, one or more fasteners 218a and 218b, a first set of adjustable mounts 220 and a second set of adjustable mounts 222.

In accordance with an embodiment, the first bracket assembly 104 may be mounted on the platform 216, by use of the one or more fasteners 218a and 218b. The first bracket assembly 104 may be securely attached on the platform 216, while the platform 216, in-turn, may be placed on a floor or on a desired horizontal plane.

A person having ordinary skill in the art may understand that the height and/or the width of the first bracket assembly 104 may be vertically and/or horizontally adjustable, based on the dimensions of the first speaker 110. Further, it is to be understood that the first bracket assembly 104 may be similar to the second bracket assembly 106. In such a scenario, the FIG. 2B may also be representative of another side view of the second bracket assembly 106. However, in such a scenario, the platform 216 and the one or more fasteners 218a and 218b may not be required.

In accordance with an embodiment, the first bracket assembly 104 may include the first set of adjustable mounts 220. The first set of adjustable mounts 220 may be provided in a radial pattern to adjustably hold the first speaker 110 at an angle with respect to the base of the first bracket assembly 104. Examples of the radial pattern are shown in FIG. 3, FIG. 4A, and FIG. 4B.

For instance, the first set of adjustable mounts 220 may be provided at a base of the first bracket assembly 104 such that an angle related to positioning of the first speaker 110 inside the first bracket assembly 104 may be adjusted. Further, each of the adjustable mount in the first set of adjustable mounts 220 may be provided at equal angular increments, such as increments of 10 degrees each. In such a scenario, if the first speaker 110 is mounted on a second adjustable mount from the first set of adjustable mounts 220, the first speaker 110 may be tilted at an angle of 10 degrees with respect to the base of the first bracket assembly 104.

A person having ordinary skill in the art may understand that the first speaker 110 may be mounted at a particular angle with respect to the base of the first bracket assembly 104, by use of the first set of adjustable mounts 220. The first speaker 110 may be attached to the particular adjustable mount by use of one or more connectors.

In accordance with an embodiment, the first bracket assembly 104 may include the second set of adjustable mounts 222 at a top end of the first bracket assembly 104, as shown. The second set of adjustable mounts 222 may be adapted to stack another bracket assembly, such as the second bracket assembly 106, on the first bracket assembly 104. The other bracket assembly may be adapted to encase another speaker, such as the second speaker 112.

A person having ordinary skill in the art may understand that the second set of adjustable mounts 222 may not be provided as a component of the first bracket assembly 104. In such a scenario, the second set of adjustable mounts 222 may be provided as a component of the other bracket assembly, such as the second bracket assembly 106. Alternatively, the second set of adjustable mounts 222 may be provided as a separate component that may be adapted to adjustably mount the other bracket assembly on the first bracket assembly 104, as a stack.

In accordance with an embodiment, the second set of adjustable mounts 222 may be provided in a radial pattern to adjustably hold the first bracket assembly 104 with the other bracket assembly. The radial pattern of the second set of adjustable mounts 222 may be similar to the radial pattern of the first set of adjustable mounts 220.

FIG. 3 illustrates an exemplary scenario to depict adjustment of bracket assemblies of a bracket system to align sound output from speakers encased in the bracket system, in accordance with an embodiment of the disclosure. With reference to FIG. 3, there is shown a side view of another bracket system 300. The bracket system 300 may include a stack of a plurality of bracket assemblies, such as the first bracket assembly 104 and the second bracket assembly 106. The bracket system 300 may include one or more additional adjustable mounts, such as a set of adjustable mounts 224, as shown. There is further shown the first set of adjustable mounts 220 and the second set of adjustable mounts 222.

A person skilled in the art may further understand that the first bracket assembly 104 and/or the second bracket assembly 106 may be provided in variety of shapes other than that illustrated in FIG. 3 for exemplary purposes. For instance, the first bracket assembly 104 and/or the second bracket assembly 106 may be one of a cuboidal shape, a spherical shape, and/or a trapezoidal shape to respectively encase the first speaker 110 and the second speaker 112 of corresponding dimensions.

In accordance with an embodiment, the one or more adjustable mounts may be provided as one or more pivotal connectors at a base end and/or a top end of each of the first bracket assembly 104 and the second bracket assembly 106, as shown. For instance, the first set of adjustable mounts 220 may be provided at the base end of the first bracket assembly 104 to tilt and adjustably mount the first speaker 110 at an angle within the first bracket assembly 104. Further, the second set of adjustable mounts 222 may be provided at the top end of the first bracket assembly 104. Alternatively, the second set of adjustable mounts 222 may be provided at the base of the second bracket assembly 106. In accordance with an embodiment, the second set of adjustable mounts 222 may be adapted to adjustably mount the second bracket assembly 106 on the first bracket assembly 104 such that the angle between the first bracket assembly 104 and the second bracket assembly 106 may be adjustable.

In accordance with an embodiment, the second set of adjustable mounts 222 may also be adapted to adjustably tilt and adjustably mount the second speaker 112 within the second bracket assembly 106. In an alternate scenario, the second bracket assembly 106 may include another set of adjustable mounts, such as the third set of adjustable mounts 224, to tilt and mount the second speaker 112 within the second bracket assembly 106. In addition, the third set of adjustable mounts 224 may be provided at the top end of the second bracket assembly 106, which may be adapted to adjustably mount another bracket assembly on the second bracket assembly 106, and so on.

In accordance with an embodiment, each set of the adjustable mounts 220, 222, and 224, may be provided as a radial pattern of pivotal threads in angular increments of certain degrees, such as 5, 10, 15, or 30 degrees. To secure components by use of one or more of the sets of adjustable mounts 220, 222, and 224, screws may be inserted at an appropriate radial position in an adjustable mount of the set of adjustable mounts 220, 222, or 224. Examples of the one or more adjustable mounts may include, but may not be limited to, one or more radial pivots, friction mapped plates, hinged plates, or groove-screw mounts.

For instance, assuming that each of the first set of adjustable mounts 220 may be provided at an angular increment of 10 degrees with respect to a previous adjustable mount (or pivotal connector) in the first set of adjustable mounts 220. A screw may be inserted at a second location (shown by arrow) in the radial pivotal pattern of the first set of adjustable mounts 220. In such a case, the first speaker 110 may be encased in the first bracket assembly 104 such that it may be tilted and secured at an angle of 10 degrees with respect to the base of the first bracket assembly 104. Similarly, a screw may be inserted at a second location (shown by arrow) in the radial pivotal pattern of the second set of adjustable mounts 222. In this case, the second bracket assembly 106 may be tilted and mounted on the first bracket assembly 104 at an angle of 10 degrees with respect to a horizontal plane, parallel to the base of the first bracket assembly 104. Accordingly, the second speaker 112 may be tilted and mounted at an angle of 10 degrees to the base of the second bracket assembly 106, based on screws inserted at the particular adjustable mount (or pivotal connector).

In accordance with an embodiment, the angle between the first bracket assembly 104 and the second bracket assembly 106 may be adjusted through an appropriate adjustable mount from the second set of adjustable mounts 222. Based on the adjustment of the angle between the two bracket assemblies 104 and 106, the sound output from the first speaker 110 and the second speaker 112 may be aligned.

In accordance with an embodiment, the sound output from the first speaker 110 and the second speaker 112 may be aligned when the first speaker 110 and the second speaker 112 are equidistant from the target listening position 108. In such a scenario, the first distance 114a between the first speaker 110 and the target listening position 108 is same as the second distance 114b between the second speaker 112 and the target listening position 108. In such a scenario, the second bracket assembly 106 is tilted and stacked on the first bracket assembly 104 in such a manner that the hemispherical radius 116 is maintained with respect to the target listening position 108, from a center point of each of the first bracket assembly 104 and the second bracket assembly 106.

In accordance with an embodiment, a sound emitting side of each of the first speaker 110 and the second speaker 112 may be directed to face towards the target listening position 108 for the alignment of the sound output. In accordance with an embodiment, the alignment of the sound output between the first speaker 110 and the second speaker 112 may correspond to a height-alignment (as explained in the FIGS. 1, 2A, and 3), a time-alignment, and/or a phase-alignment. In accordance with an embodiment, a first sound output from the first speaker 110 may be time-aligned with respect to a second sound output from the second speaker 112, based on the adjustment of the angle between the first bracket assembly 104 and the second bracket assembly 106. Further, the first sound output and the second sound output may be phase-aligned, based on the adjustment of the angle between the first bracket assembly 104 and the second bracket assembly 106.

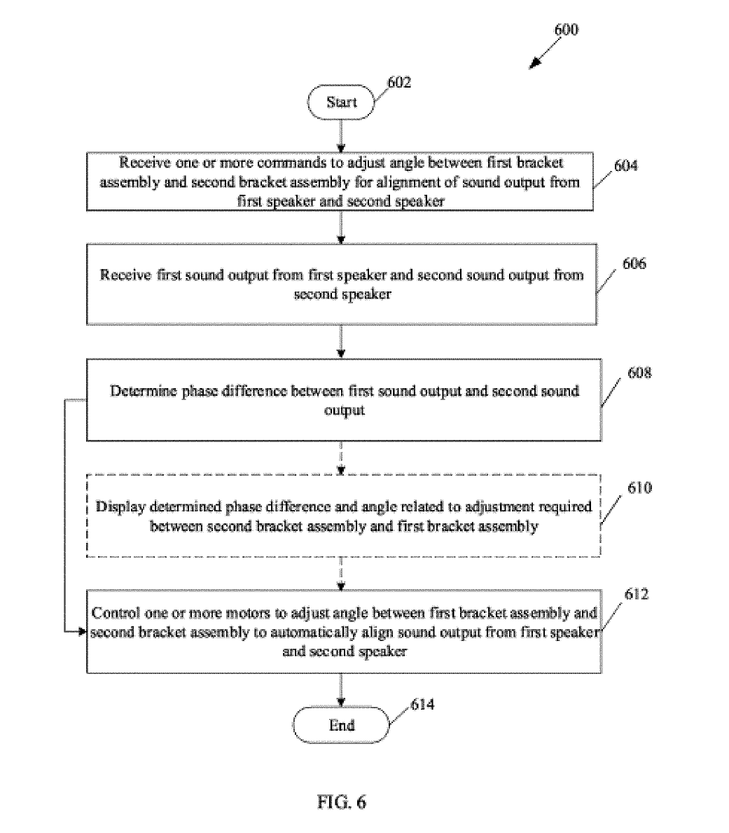

A person having ordinary skill in the art may understand that the angle between first bracket assembly 104 and the second bracket assembly 106 may be adjusted based on one of a mechanical adjustment and/or an electrical adjustment. The electrical adjustment of the angle between the first bracket assembly 104 and the second bracket assembly 106 is further explained in FIGS. 5 and 6.

FIGS. 4A and 4B illustrate exemplary radial patterns of pivotal connectors of a bracket system, in accordance with an embodiment of the disclosure. With reference to FIG. 4A, there is shown a first radial pattern 402 of adjustable mounts. Each adjustable mount may be referred to as a pivotal connector. In accordance with an embodiment, the first radial pattern 402 may include two sets of adjustable mounts provided at opposite ends of a bracket assembly. A single adjustable mount in each of the two sets of adjustable mounts may be prodded in angular increments of certain degrees starting from a level parallel to a base of the given bracket assembly. A first set of the adjustable mounts may be provided in an upward direction from the base of a bracket assembly, on one end of the bracket assembly. A second set of these adjustable mounts may be provided in a downward direction from the base of the bracket assembly, on the other end of the bracket assembly.

With reference to FIG. 4B, there is shown a second radial pattern 404 of adjustable mounts (or pivotal connectors). In accordance with an embodiment, the second radial pattern 404 may be similar to the first radial pattern 402. The second radial pattern 404 may include two sets of adjustable mounts provided at opposite ends from the base of the bracket assembly. A single adjustable mount in each of the two sets of adjustable mounts may be provided in angular increments of certain degrees, that may enable adjustment of an angle between “+45” degrees to “−45” degrees angle with respect to the base of the given bracket assembly. One of the two sets of adjustable mounts may be provided at one end of the bracket assembly. The other set of adjustable mounts may be symmetrically provided, on the other end of the bracket assembly.

A person having ordinary skill in the art may understand that the first radial pattern 402 and thee second radial pattern 404 may be used to adjustably tilt and mount one bracket assembly on another bracket assembly. Alternatively, the radial patterns 402 and 404 may be used to adjustable tilt and mount a speaker within a bracket assembly. Further, the radial patterns 402, 404, and the radial patterns explained in the FIG. 2B and FIG. 3 are for exemplary purposes and should not be construed to limit the scope of the disclosure.

FIG. 5 is a block diagram that illustrates an exemplary device for electrical adjustment of a bracket system for speakers for surround sound effect, in accordance with an embodiment of the disclosure. FIG. 5 is described in conjunction with elements from FIGS. 1, 2A, 2B, 3, 4A, and 4B. With reference to FIG. 5, there is shown an exemplary device, such as electrical adjustment unit 502, for electrical adjustment of a bracket system, such as the bracket system 102 or 300, for speakers for surround sound effect. The electrical adjustment unit 502 may include one or more circuits 504 and one or more motors 506. The one or more circuits 504 may include a processor 504a, a transceiver 504b, a memory 504c, and one or more audio-input devices, such as a microphone 504d. There is further shown an electronic device 508 and communication network 510. The electronic device 508 may establish a communicative coupling with the electrical adjustment unit 502 via the communication network 510. The electronic device 508 may be configured to communicate with the electrical adjustment unit 502 with respect to the electrical adjustment of the bracket system 102 or 300. The processor 504a may be communicatively coupled to the transceiver 504b, the memory 504c, and the microphone 504d. The transceiver 504b may be configured to facilitate communication with the electronic device 508 via the communication network 510.

In accordance with an embodiment, the electrical adjustment unit 502 may be configured to electrically adjust the angle between the second bracket assembly 106 and the first bracket assembly 104. A person having ordinary skill in the art may understand that the one or more motors 506 may not necessarily be a component of the electrical adjustment unit 502. In such a scenario, the one or more motors 506 may be communicatively coupled with the electrical adjustment unit 502, through the transceiver 504b and controlled, based on commands received from the processor 504a of electrical adjustment unit 502 and/or the electronic device 508. Similarly, in accordance with an embodiment, the microphone 504d may not necessarily be a component of the electrical adjustment unit 502. In such a case, the microphone 504d may be included within one or both speakers encased in the bracket system 102 or 300.

The processor 504a may comprise suitable logic, circuitry, interfaces, and/or code that may be configured to execute a set of instructions stored in the memory 504c. The processor 504a may be implemented, based on a number of processor technologies known in the art. In accordance with an embodiment, the processor 504a may be configured to control the one or more motors 506, based on sound captured by the microphone 504d.Examples of the processor 504a may be an X86-based processor, a Reduced Instruction Set Computing (RISC) processor, an Application-Specific Integrated Circuit (ASIC) processor, a Complex Instruction Set Computing (CISC) processor, and/or other processors or control circuits.

The transceiver 504b may comprise suitable logic, circuitry, interfaces, and/or code that may be configured to communicate with the electronic device 508 and/or the one or more motors 506, via the communication network 510. The transceiver 504b may implement known technologies to support wired or wireless communication with the communication network 510. The transceiver 504b may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a local buffer.

The transceiver 504b may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies, such as Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (such as IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

A person having ordinary skill in the art may understand that in certain scenarios the transceiver 504b may also function as the common network module 214 provided as a communication interface for each of the first speaker 110 and the second speaker 112. In such a case, at least one of the first speaker 110 and/or the second speaker 112 may correspond to a wireless speaker that may be connected to other electronic devices wirelessly connected to that network. Examples of such electronic devices that may be wirelessly connected may include, but may not be limited to, a smartphone, a personal computer, any other electronic device that may be configured to wirelessly control playback of sound at the first speaker 110 and/or the second speaker 112.

The memory 504c may comprise suitable logic, circuitry, and/or interfaces that may be configured to store a set of instructions executable by the processor 504a. In accordance with an embodiment, the memory 504c may be further configured to store a look-up table associated with the adjustment of the angle between the first bracket assembly 104 and the second bracket assembly 106. For instance, the look-up table may include appropriate angular adjustment values associated with given phase difference values between sound output from the first speaker 110 (encased in the first bracket assembly 104) and the second speaker 112 (encased in the second bracket assembly 106). In accordance with an embodiment, the values of the look-up table may be determined based on a real-time auto-configuration of the bracket system 102 or 300. Alternatively, the values of the look-up table may be pre-stored based on configuration data provided by a manufacturer of the bracket system 102 or 300 (and/or the first speaker 110 and the second speaker 112 encased within the bracket system 102 or 300). Examples of implementation of the memory 504c may include, but are not limited to, Random Access Memory (RAM), Read Only Memory (ROM), Hard Disk Drive (HDD), and/or a Secure Digital (SD) card.

A person having ordinary skill in the art may understand that the memory 504c may not be included as a component separate from the processor 504a. In such a scenario, the memory 504c may be implemented within the processor 504a as one or more registers that may be configured to store the look-up table.

The microphone 504d may comprise suitable logic, circuitry, interfaces, and/or code that may be configured to capture sound output from the first speaker 110 and/or the second speaker 112. In accordance with an embodiment, the processor 504a may be configured to analyze the sound output captured by the microphone 504d to determine one or more sound characteristics associated with the captured sound output. Examples of the one or more sound characteristics may at least include, but may not be limited to, an audio-phase information, an audio-frequency information, and/or an audio-time shift information, associated with the captured sound output.

In accordance with an embodiment, the one or more sound characteristics may further include information related to a model of the first speaker 110 and/or the second speaker 112, and audio-channel information associated with the first sound output and/or the second sound output, and the like. In accordance with an embodiment, the processor 504a may be configured to determine an angle of adjustment required between the first bracket assembly 104 and the second bracket assembly 106 (and/or the angle between the first speaker 110 and the second speaker 112), to align the sound output from the two speakers 110 and 112. The processor 504a may be may be configured to determine the angle of adjustment based at least on the one or more sound characteristics and the values stored in the look-up. In accordance with an embodiment, the processor 504a may control the one or more motors 506, based on the determined angle of adjustment.

The one or more motors 506 may be configured to electrically adjust the angle of tilt between components of the bracket system 102 or 300 and/or a speaker and a bracket assembly encasing the speaker. For example, an angle between the first bracket assembly 104 and the second bracket assembly 106 may be electrically adjusted by the one or more motors 506 (based on angular adjustment at the second set of adjustable mounts 222). In accordance with an embodiment, the one or more motors 506 may include, but may not be limited to, a servo motor and/or a step motor. In accordance with an embodiment, the one or more motors 506 may be controlled by the processor 504a and/or the electronic device 508.

The electronic device 508 may correspond to a user-terminal used by a user of the bracket system, such as the bracket system 102 or 300, to electronically adjust the bracket system. The electronic device 508 may be configured to facilitate a user to initiate automatic adjustment of the angle between the second bracket assembly 106 and the first bracket assembly 104. Based on the automatic adjustment, sound output between the first speaker 110 and the second speaker 112 (encased within the first bracket assembly 104 and the second bracket assembly 106, respectively) may be aligned. The alignment of the sound output may correspond to a time-alignment, a height-alignment, and/or a phase-alignment. Examples of the electronic device 508 may include, but are not limited to, a smartphone, a wearable device, a tablet computer, a personal computer, one or more sensors (e.g., proximity sensor, light sensor, presence sensor, and the like), a remote control device, and/or other electronic device.

In accordance with an embodiment, a user may mount the second bracket assembly 106 on the first bracket assembly 104 such that a base of the first bracket assembly 104 may be parallel to a base of the second bracket assembly 106. In such an arrangement of the first bracket assembly 104 and the second bracket assembly 106, the angle between the first bracket assembly 104 and the second bracket assembly 106 may be close to zero degrees. The user may encase the first speaker 110 within the first bracket assembly 104 and the second speaker 112 within the second bracket assembly 106. In such a scenario, similar to the first bracket assembly 104 and the second bracket assembly 106, the angle between the first speaker 110 and the second speaker 112 may also be close to zero degrees. At this point, the user may switch on first speaker 110 and the second speaker 112 and play one or more sample sound tracks from the first speaker 110 and the second speaker 112.

In operation, the microphone 504d may capture a sound output associated with the one or more sample sound tracks played by the first speaker 110 and the second speaker 112. The processor 504a may be configured to determine one or more sound characteristics associated with the captured sound output. For instance, the one or more sound characteristics may include a phase difference between the sound outputs from each of the two speakers 110 and 112.

In accordance with an embodiment, the user may gradually tilt the second bracket assembly 106 mounted on the first bracket assembly 104, to adjust an angle between the first bracket assembly 104 and the second bracket assembly 106. For instance, the user may sequentially secure the second bracket assembly 106 at each subsequent adjustable mount through the one or more pivotal connectors, such as the second set of adjustable mounts 222, which connect the first bracket assembly 104 and the second bracket assembly 106. At each adjustment step, the one or more sample sound tracks may be played by each of the first speaker 110 and the second speaker 112. The microphone 504d may capture the sound output from the first speaker 110 and the second speaker 112 at each such adjustment step. The processor 504a may simultaneously determine the one or more sound characteristics of the currently captured sound output (e.g., the phase-difference between the sound output from each of the first speaker 110 and the second speaker 112).

In accordance with an embodiment, the processor 504a may be configured to compare the phase-differences between the sound outputs at each of the various adjustment steps. The processor 504a may be configured to determine an optimum adjustment angle between the first bracket assembly 104 and the second bracket assembly 106, based on the comparison. In accordance with an embodiment, the optimum adjustment angle may correspond to an angle at which the phase-difference between the sound outputs from the two speakers 110 and 112 may be close to zero.

A person having ordinary skill in the art may understand that the scope of the disclosure may not be limited to determination of the optimum adjustment angle, based on the adjustment of angles between the first bracket assembly 104 and the second bracket assembly 106. In an embodiment, the user may adjust an angle of mounting of the first speaker 110 within the first bracket assembly 104 and/or the second speaker 112 within the second bracket assembly 106. Alternatively, the user may adjust the height and/or the width of one or both of the two bracket assemblies, 104 and 106. In both of the aforementioned cases, the optimum adjustment angle may be determined, based on the type of adjustment made by the user.

In accordance with an embodiment, the optimum angle of adjustment determined by the processor 504a may be communicated to the electronic device 508. The communicated optimum angle of adjustment may be displayed via a user interface (UI) rendered on a display screen of the electronic device 508. In instances when the electrical adjustment unit 502 includes a display screen, the UI may also be rendered at the display screen of the device of the electrical adjustment unit 502. The UI may display a recommendation of the optimum angle of adjustment. The UI may further display one or more configurations of the bracket system, such as the bracket system 102 or 300, and/or the first speaker 110 and the second speaker 112, for optimum alignment of the sound output from the two speakers 110 and 112.

In accordance with an embodiment, the processor 504a may be configured to control the one or more motors 506 for adjustment of the bracket system, such as the bracket system 102 or 300, to align the sound output from the two speakers 110 and 112. Such control may be based on one or more commands received from the electronic device 508. Alternatively, the processor 504a may be configured to automatically control the one or more motors 506 for the adjustment, without a user input.

In accordance with an embodiment, the optimum angle of adjustment may be determined during an initial configuration (a first-time use or a trial use) of the bracket system 102 or 300 and the two speakers 110 and 112. When the first speaker 110 and the second speaker 112 is used with same bracket system 102 or 300, the user may switch on the electrical adjustment unit 502 for auto-alignment of the sound output from the two speakers 110 and 112. Such auto-alignment may be based on adjustment of the angle between the first bracket assembly 104 and the second bracket assembly 106 of the bracket system 102 or 300. In accordance with an embodiment, the user may mechanically adjust the bracket system 102 or 300, based on the displayed optimum angle of adjustment.

In accordance with an alternate embodiment, one or both of the first speaker 110 and the second speaker 112 may include a microphone. The microphone may continuously capture the sound output from the first speaker 110 and the second speaker 112, while sound is played by the speakers 110 and 112. In such a scenario, one or both of first speaker 110 and the second speaker 112 may include one or more circuitry, logic, and/or code configured to determine sound characteristics associated with the captured sound output. The determined sound characteristics may then be transmitted to the electrical adjustment unit 502 for further processing.

FIG. 6 is a flow chart that illustrates a method to control adjustment of a bracket system for speakers for surround sound effect, in accordance with an embodiment of the disclosure. With reference to FIG. 6, there is shown a flow chart 600. The flow chart 600 is described in conjunction with elements from FIGS. 1, 2A, 2B, 3, 4A, 4B, and 5. The method starts at step 602 and proceeds to step 604.

At step 604, one or more commands may be received for adjustment of an angle between the first bracket assembly 104 and second bracket assembly 106 for alignment of sound output from first speaker 110 and second speaker 112. In accordance with an embodiment, a user may provide an input via the UI rendered at the electronic device 508 (and/or the electrical adjustment unit 502). The input may correspond to the one or more commands for adjustment of the angle between the bracket assemblies, such as the first bracket assembly 104 and second bracket assembly 106.

At step 606, a first sound output from the first speaker 110 and a second sound output from the second speaker 112 may be received. In accordance with an embodiment, the microphone 504d may be configured to capture the first sound output and/or the second sound output.

At step 608, a phase difference between the first sound output and the second sound output may be determined. In accordance with an embodiment, the processor 504a may be configured to determine one or more sound characteristics associated with the first sound output and/or the second sound output. Such determination may occur by use of the captured sound by the microphone 504d. Based on the determined one or more sound characteristics, the processor 504a may be configured to determine the phase difference between the first and the second sound output. Further, the processor 504a may determine an optimum angle of adjustment between the first bracket assembly 104 and the second bracket assembly 106 based on the determined phase difference and/or the look-up table stored in the memory 504c. In accordance with an embodiment, the optimum angle of adjustment may correspond to an angle between the first bracket assembly 104 and the second bracket assembly 106 at which the phase difference between the first and the second sound output may be close to zero, as explained in the FIG. 5.

At step 610, the determined phase difference and the angle related to adjustment required between the second bracket assembly 106 and the first bracket assembly 104 may be displayed. In accordance with an embodiment, the angle related to the adjustment for alignment of the first and the second sound output may be displayed to the user, via the UI. The UI may be rendered on a display screen of the electronic device 508 (and/or the electrical adjustment unit 502).

At step 612, the one or more motors 506 may be controlled to adjust an angle between the second bracket assembly 106 and the first bracket assembly 104. The second bracket assembly 106 may be adjustably mounted on the first bracket assembly 104 by use of pivotal connectors, such as the sets of adjustable mounts 220 to 224. In accordance with an embodiment, the user may provide an input through the UI to adjust the angle between the second bracket assembly 106 and the first bracket assembly 104. Based on the user input, the processor 504a may control the one or more motors 506 to adjust the angle between the second bracket assembly 106 and the first bracket assembly 104. Alternatively, the processor 504a may automatically perform the adjustment of the angle by controlling the one or more motors 506, based on the determined optimum angle of adjustment. The control may pass to end step 614.

A person having ordinary skill in the art may understand that the step 610 may be skipped in certain scenarios. In such scenarios, the adjustment of the angle between the first bracket assembly 104 and the second bracket assembly 106 may be performed automatically, with or without user input and/or user confirmation. Further, in another scenario, the step 610 may be performed after step 612. In such a case, the angle of adjustment may be displayed to the user after an automatic adjustment of the angle has been performed, as per the step 612.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted to carry out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features that enable the implementation of the methods described herein, and which when loaded in a computer system is able to carry out these methods. Computer program, in the present context, means any expression, in any language, code or notation, of a set of instructions intended to cause a system with an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without deviation from the scope of the present disclosure. In addition, many modifications may be made to adapt a particular situation or material to the teachings of the present disclosure without deviation from its scope. Therefore, it is intended that the present disclosure not be limited to the particular embodiment disclosed, but that the present disclosure will include all embodiments falling within the scope of the appended claims.

1. A bracket system, comprising:
a first bracket assembly configured to hold a first speaker; and
a second bracket assembly configured to hold a second speaker, wherein said second bracket assembly is mounted on said first bracket assembly, wherein an angle between said second bracket assembly and said first bracket assembly is adjustable for an alignment of sound output from said first speaker within said first bracket assembly and said second speaker within said second bracket assembly.

2. The bracket system of claim 1, wherein at least one of said first bracket assembly or said second bracket assembly comprises a power strip to supply electric power to said first speaker and said second speaker.

3. The bracket system of claim 1, wherein at least one of said first bracket assembly or said second bracket assembly comprises a common network module for said first speaker and said second speaker.

4. The bracket system of claim 1, wherein said first speaker corresponds to one of a base speaker or a floor standing speaker, and wherein said second speaker corresponds to an aerial speaker.

5. The bracket system of claim 1, wherein said alignment of sound output from said first speaker within said first bracket assembly and said second speaker within said second bracket assembly corresponds to at least one of a time-alignment, a phase-alignment, or a height-time alignment.

6. The bracket system of claim 1, wherein said first speaker is aligned with respect to said second speaker such that said first speaker and said second speaker are equidistant from a target listening position, based on an adjustment of said angle between said second bracket assembly and said first bracket assembly.

7. The bracket system of claim 1, wherein a sound emitting side of each of said first speaker and said second speaker is directed to face towards a target listening position for said alignment of said sound output.

8. The bracket system of claim 1, wherein a first sound output from said first speaker is time-aligned with respect to a second sound output from said second speaker, based on an adjustment of said angle between said second bracket assembly and said first bracket assembly.

9. The bracket system of claim 1, wherein a first sound output from said first speaker and a second sound output of said second speaker is phase-aligned, based on an adjustment of said angle between said second bracket assembly and said first bracket assembly.

10. The bracket system of claim 1, wherein said second bracket assembly is mounted on said first bracket assembly based on at least one pivotal connector.

11. The bracket system of claim 1, wherein said first speaker corresponds to a perimeter speaker of a surround sound system and said second speaker corresponds to one of an aerial speaker or a ceiling speaker of said surround sound system.

12. The bracket system of claim 1, wherein each of said first bracket assembly and said second bracket assembly comprises at least one of a clamp, a padded plate, a bracket member, or a grid rail, configured to hold said first speaker within said first bracket assembly and said second speaker within said second bracket assembly.

13. The bracket system of claim 1, wherein one end of said first bracket assembly is attached on a mount based on at least one fastener.

14. The bracket system of claim 1, wherein said angle is adjustable via a mechanical adjustment based on at least one pivotal connector, wherein said at least one pivotal connector adjustably connect said second bracket assembly and said first bracket assembly.

15. The bracket system of claim 1, wherein said angle is adjustable via an electrical adjustable unit associated with at least one pivotal connector, wherein said at least one pivotal connector adjustably connect said second bracket assembly and said first bracket assembly.

16. The bracket system of claim 15, wherein said electrical adjustment unit includes a motor and at least one circuit, wherein said at least one circuit is configured to control said motor, and wherein said motor corresponds to a step motor or a servo motor.

17. The bracket system of claim 16, wherein said at least one circuit is further configured to receive at least one control command from an electronic device for said adjustment of said angle between said second bracket assembly and said first bracket assembly.

18. The bracket system of claim 16, wherein said at least one circuit is further configured to determine a phase difference between a first sound output of said first speaker and a second sound output of said second speaker, wherein said angle between said second bracket assembly and said first bracket assembly is automatically adjusted based on said determined phase difference.

19. The bracket system of claim 1, wherein each of said first speaker and said second speaker comprises at least one speaker driver, wherein said at least one speaker driver corresponds to height channels aligned based on said first bracket assembly and said second bracket assembly to produce a surround sound multichannel audio, wherein said height channels produce said surround sound multichannel audio based on an adjustment of said angle between said second bracket assembly and said first bracket assembly.

20. The bracket system of claim 1, wherein said first bracket assembly is vertically or horizontally adjustable based on first dimensions of said first speaker to accommodate said first speaker, and wherein said second bracket assembly is vertically or horizontally adjustable based on second dimensions of said second speaker to accommodate said second speaker.
